(19) United States
(12) Patent Application Publication
(10) Pub. No.: US 2014/0002787 A1
(43) Pub. Date: Jan. 2, 2014

(54) Temple Tip Device for Attaching to Glasses Temple

(71) Applicant: Wen-Tse Huang, Kaohsiung City (TW)

(72) Inventor: Wen-Tse Huang, Kaohsiung City (TW)

(21) Appl. No.: 13/537,183

(22) Filed: Jun. 29, 2012

(51) Int. Cl. G02C 5/16

(52) U.S. Cl. 351/113

(57) ABSTRACT

A temple tip device includes a temple tip for attaching to a tail portion of a glasses temple of a pair of eyeglasses. The temple tip device further includes a zigzag-shaped resilient strip and a subsidiary temple sleeve. An end of the resilient strip is connected to one of inner and outer ends of the temple tip, and another end of the resilient strip is connected to one of inner and outer ends of the subsidiary temple sleeve. The subsidiary temple sleeve is spaced from the temple tip, and a retraction space is developed by the resilient strip between the subsidiary temple sleeve and the temple tip, allowing the subsidiary temple sleeve to resiliently clip and/or contact a head of a glasses wearer who wears the pair of eyeglasses.

### BACKGROUND OF THE INVENTION

1. Field of the Invention

The present invention relates to a temple tip device for attaching to a glasses temple and, more particularly, to a resilient temple tip device for securing a pair of eyeglasses to a glasses wearer's head.

2. Description of the Related Art

A pair of conventional eyeglasses generally includes a glasses frame, two lenses mounted on the glasses frame, and two foldable glasses temples connected to both sides of the glasses frame to allow the eyeglasses to be worn on a glasses wearer's head. In general, each glasses temple includes a tail portion which is bent downwards for clipping or hooking a glasses wearer's temporal region as well as ear. However, the conventional eyeglasses have certain shortcomings. For instance, wide glasses frames cannot make glasses temples closely attach to heads of wearers, and the distance between two glasses temples is generally not adjustable. Further, when a clamping force of the glasses temples is regulated by bending the glasses temples, the eyeglasses' appearance will be adversely influenced, and the glasses temples may be deformed or damaged due to the bending. Additionally, the eyeglasses often come off from heads of wearers who strenuously exercise due to limited holding capacity of the glasses temples.

### BRIEF SUMMARY OF THE INVENTION

In order to overcome the deficiencies of the prior art, an objective of the present invention is to provide a resilient temple tip device. The temple tip device is adapted to be mounted to a glasses temple of a pair of eyeglasses for stably wearing the eyeglasses on a head of a glasses wearer, while allowing the glasses wearer to feel comfortable, secure, and safe.

To achieve the foregoing objective, a temple tip device of the present invention includes a temple tip, a resilient strip, and a subsidiary temple sleeve. The temple tip includes inner and outer ends spaced apart in a length direction. The inner end of the temple tip is adapted to be engaged with a tail portion of a glasses temple of a pair of eyeglasses. The resilient strip includes first and second ends and a middle section intermediate the first and second ends of the resilient strip. The first end of the resilient strip is connected to one of the inner and outer ends of the temple tip. The subsidiary temple sleeve includes inner and outer ends spaced apart in the length direction. The second end of the resilient strip is connected to one of the inner and outer ends of the subsidiary temple sleeve. The subsidiary temple sleeve is spaced from the temple tip in a width direction perpendicular to the length direction. The middle section of the resilient strip can be resiliently compressed in the width direction and defines a retraction space between the subsidiary temple sleeve and the temple tip, allowing the subsidiary temple sleeve to be moved toward the temple tip in the width direction when the pair of eyeglasses is worn on a head of a glasses wearer.

In a preferred form, the resilient strip is formed in a zigzag shape, the first end of the resilient strip is connected to the outer end of the temple tip, and the second end of the resilient strip is connected to the inner end of the subsidiary temple sleeve.

In another preferred form, the resilient strip is formed in an M shape with the middle section of the resilient strip having V-shaped cross sections, the first end of the resilient strip is connected to the inner end of the temple tip, and the second end of the resilient strip is connected to the inner end of the subsidiary temple sleeve.

Preferably, the subsidiary temple sleeve has a length in the length direction approximately the same as that of the temple tip in the length direction. The inner end of the subsidiary temple sleeve faces the inner end of the temple tip, and the outer end of the subsidiary temple sleeve faces the outer end of the temple tip.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 a schematic view showing a pair of eyeglasses provided with two temple tip devices according to a first embodiment of the present invention.

FIG. 2 is a schematic view showing the temple tip device of FIG. 1 mounted to a tail portion of a glasses temple of the pair of eyeglasses of FIG. 1.

FIG. 3 is a schematic view similar to FIG. 2, with a resilient strip of the temple tip device being compressed.

FIG. 4 is a schematic view similar to FIG. 3, showing a temple tip device of a second embodiment of the present invention.

### DETAILED DESCRIPTION OF THE INVENTION

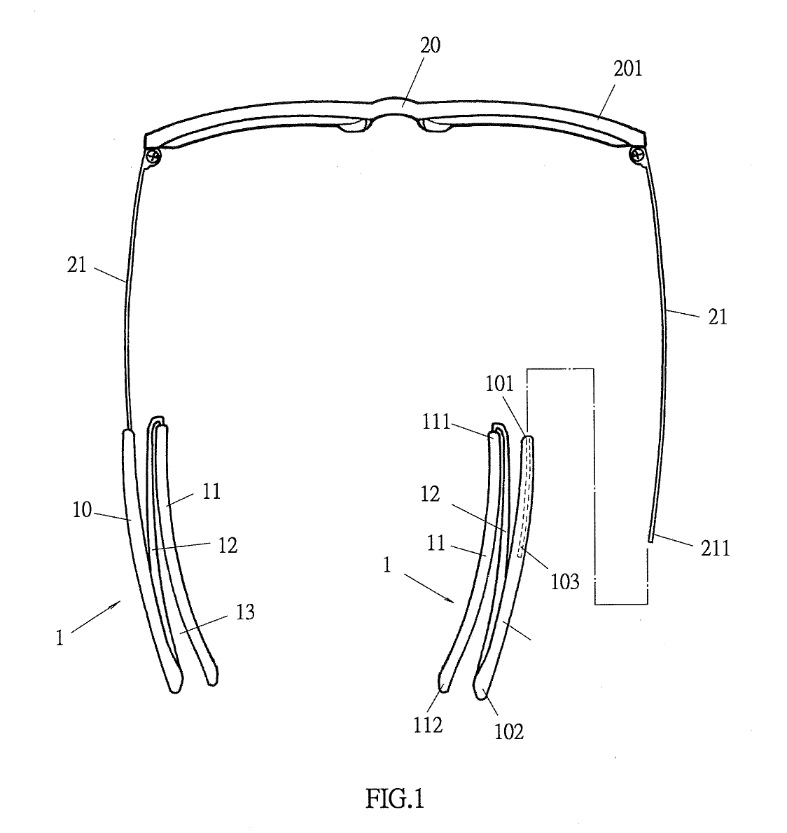

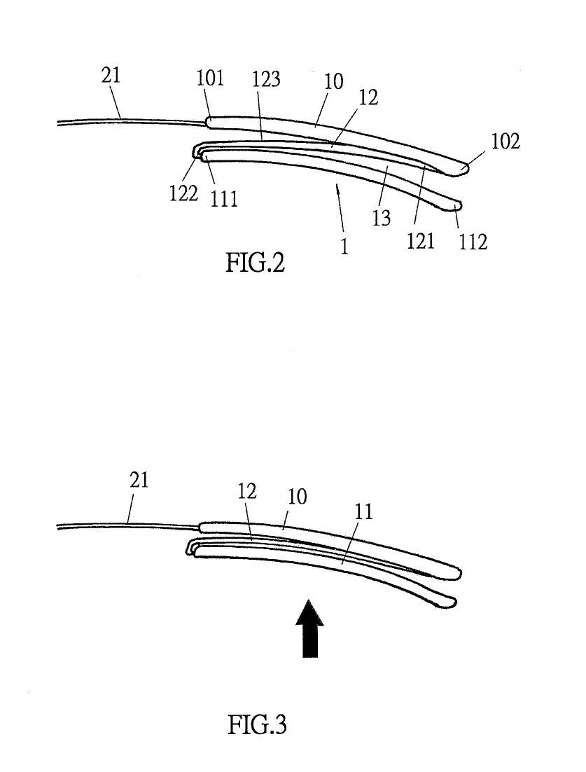

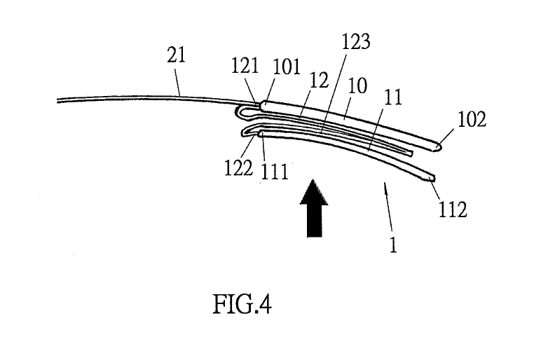

A temple tip device according to a first embodiment of the present invention is shown in FIGS. 2 and 3 of the drawings and generally designated 1. Referring to FIG. 1, the temple tip device 1 is adapted for attaching to a pair of eyeglasses 20 for clipping and/or contacting a glasses wearer's temporal region and/or ear. The eyeglasses 20 includes a metal glasses frame 201 and two foldable glasses temples 21 connected to both sides of the glasses frame 201. Each glasses temple 21 includes a tail portion 211 distal to the glasses frame 201. The tail portion 211 of each glasses temple 21 may be curved to extend over the glasses wearer's ear.

The temple tip device 1 of the present invention includes a temple tip 10, a subsidiary temple sleeve 11, and a resilient strip 12 interconnected between the temple tip 10 and the subsidiary temple sleeve 11. The temple tip 10 includes inner and outer ends 101 and 102 spaced apart in a length direction parallel with the glasses temple 21. In the embodiment, a connecting hole 103 is formed in the inner end 101 of the temple tip 10 for receiving and engaged with the tail portion 211 of one of the glasses temples 21 (see FIG. 1).

The resilient strip 12 includes first and second ends 121 and 122 and a middle section 123 intermediate the first and second ends 121 and 122 of the resilient strip 12. The first end 121 of the resilient strip 12 is connected to one of the inner and outer ends 101 and 102 of the temple tip 10. In the embodiment, the resilient strip 12 is formed in a zigzag shape, and the first end 121 of the resilient strip 12 is connected to the outer end 102 of the temple tip 10.

The subsidiary temple sleeve 11 includes inner and outer ends 111 and 112 spaced in the length direction. The subsidiary temple sleeve 11 is spaced from the temple tip 10 in a width direction perpendicular to the length direction, and the second end 122 of the resilient strip 12 is connected to one of the inner and outer ends 111 and 112 of the subsidiary temple sleeve 11. In the embodiment, the second end 122 of the resilient strip 12 is connected to the inner end 111 of the subsidiary temple sleeve 11, so that a retraction space 13 is defined by the middle section 123 of the resilient strip 12 between the subsidiary temple sleeve 11 and the temple tip 10, allowing the subsidiary temple sleeve 11 to be moved toward the temple tip 10 in the width direction (see the arrow shown in FIG. 3). Further, the subsidiary temple sleeve 11 has a length in the length direction approximately the same as that of the temple tip 10 in the length direction.

In use, when the pair of eyeglasses 20 having the temple tip devices 1 of the present invention is worn by one wearer on his/her head, each subsidiary temple sleeve 11 is actually touch and/or contact the wearer's head, and each resilient strip 12 will be resiliently compressed in the width direction (see FIG. 3), so that each subsidiary temple sleeve 11 can securely contact and/or clip the wearer's head due to an elastic force of each resilient strip 12. Namely, by the retraction space 13, the subsidiary temple sleeve 11 of each temple tip device 1 can be moved relative to the temple tip 10 in the width direction to resiliently clip or contact the wearer's head. On the other hand, the subsidiary temple sleeves 11 and the resilient strips 12 revert to their initial positions when the pair of eyeglasses 20 is taken off. In virtue of the subsidiary temple sleeves 11 and the resilient strips 12 of the present invention, the pair of eyeglasses 20 provided with the temple tip devices 1 will match different wearers' head sizes and securely touch wearers' heads, and the glasses wearers will wear the eyeglasses stably and feel comfortably. Further, the resilient strip 12 can absorb vibration or shock to prevent the pair of eyeglasses 20 from drop when the glasses wearers engage in exercise.

Now that the basic teachings of the present invention have been explained, many extensions and variations will be obvious to one having ordinary skill in the art. The temple tip device 1 shown in FIG. 4 is a modification of that shown in FIGS. 1 through 3. In particular, the subsidiary temple sleeve 11 and the temple tip 10 are interconnected by the resilient strip 12 and spaced in the width direction. The resilient strip 12 has an M-shaped profile with the middle section 123 of the resilient strip 12 having V-shaped cross sections. The first end 121 of the resilient strip 12 is connected to the inner end 101 of the temple tip 10, and the second end 122 of the resilient strip 12 is connected to the inner end 111 of the subsidiary temple sleeve 11. The resilient strip 12 of this embodiment can improve stability of the pair of eyeglasses 20 worn by the glasses wearers.

It can be appreciated that the first and second ends 121 and 122 of the resilient strip 12 may be connected to the temple tip 10 or the subsidiary temple sleeve 11 by either a stationary or a detachable mean. The stationary mean includes riveting, welding, adhesive-based bonding, or hot melt glue, etc.; the detachable mean includes insertion connection, lockup with a bolt, or attachment with a snap-on fastener, etc. Furthermore, the resilient strip 12 can be manufactured to have different angles or shapes and be replaced by requirements for distinct holding capacity supplied to the glasses temple 21 of the eyeglasses 20. Further, one layer of latex film or another comfortable film may be coated on an outer surface of the subsidiary temple sleeve 11 for the purpose of more comfort felt by skin and more friction between the subsidiary temple sleeve 11 and the wearer's head to prevent the pair of eyeglasses 20 from drop.

The temple tip device 1 of the present invention may be attached to the tail portion 211 of each glasses temple 21 in the production of the eyeglasses 20. On the other hand, the temple tip device 1 of the present invention may be used to replace an old temple tip of a used eyeglasses, allowing the used eyeglasses has the function of the temple tip device 1. Further, the subsidiary temple sleeve 11 can be made of plastic, rubber, or other suitable materials. Preferably, the subsidiary temple sleeve 11 is made of magnet, crystal, agate or jade which has the characteristics to provide the effects of stress relief and mind-tranquilizing when the pair of eyeglasses 20 is worn by the glasses wearer. Furthermore, the subsidiary temple sleeve 11 can be removed from the resilient strip 12 and be replaced with one made of a different material.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A temple tip device for attaching to a glasses temple of a pair of eyeglasses comprising:
a temple tip including inner and outer ends spaced apart in a length direction, with the inner end of the temple tip adapted to be engaged with a tail portion of the glasses temple;
a resilient strip including first and second ends and a middle section intermediate the first and second ends of the resilient strip, with the first end of the resilient strip connecting to one of the inner and outer ends of the temple tip; and
a subsidiary temple sleeve including inner and outer ends spaced apart in the length direction, with the second end of the resilient strip connecting to one of the inner and outer ends of the subsidiary temple sleeve, with the subsidiary temple sleeve spaced from the temple tip in a width direction perpendicular to the length direction,
wherein the middle section of the resilient strip can be compressed in the width direction to allow the subsidiary temple sleeve to be moved toward the temple tip in the width direction when the pair of eyeglasses is worn on a head of a glasses wearer.

2. The temple tip device according to claim 1, with the resilient strip formed in a zigzag shape, with the first end of the resilient strip connected to the outer end of the temple tip, with the second end of the resilient strip connected to the inner end of the subsidiary temple sleeve, with the inner end of the subsidiary temple sleeve facing the inner end of the temple tip, and with the outer end of the subsidiary temple sleeve facing the outer end of the temple tip.

3. The temple tip device according to claim 2, with a connecting hole formed in the inner end of the temple tip for receiving and engaged with the tail portion of the glasses temple.

4. The temple tip device according to claim 1, with the resilient strip formed in an M shape, with the middle section of the resilient strip having V-shaped cross sections, with the first end of the resilient strip connected to the inner end of the temple tip, and with the second end of the resilient strip connected to the inner end of the subsidiary temple sleeve.

5. The temple tip device according to claim 4, with the subsidiary temple sleeve having a length in the length direction approximately the same as that of the temple tip in the length direction, with the inner end of the subsidiary temple sleeve facing the inner end of the temple tip, and with the outer end of the subsidiary temple sleeve facing the outer end of the temple tip.
